(19) United States
(12) Patent Application Publication
(10) Pub. No.: US 2023/0166691 A1
(43) Pub. Date: Jun. 1, 2023

(54) WIPER BLADE, IN PARTICULAR FOR A MOTOR VEHICLE

(71) Applicant: Robert Bosch GmbH, Stuttgart (DE)

(72) Inventors: Helmut Depondt, Boutersem (BE); Mathijs Sinnaeve, Tienen (BE)

(21) Appl. No.: 18/070,630

(22) Filed: Nov. 29, 2022

(30) Foreign Application Priority Data
Nov. 29, 2021 (DE) 102021213401.7

(51) Int. Cl. B60S 1/38

(52) U.S. Cl. CPC B60S 1/3805; B60S 1/3808

(57) ABSTRACT

A wiper blade (10), in particular for a motor vehicle. Said wiper blade comprises a wiper strip (12) and a heating element (32). The heating element (32) is designed to be self-regulating.

### BACKGROUND OF THE INVENTION

The invention relates to a wiper blade, in particular for a motor vehicle, according to the preamble of the independent claim.

Some wiper blades with a wiper strip and a heating element are already known.

For example, DE 10 2020 200 342 A1 shows such a wiper blade in which a heating element is arranged in a wind deflector strip of the wiper strip.

### SUMMARY OF THE INVENTION

The wiper blade according to the invention has the advantage that the heating element is designed to be self-regulating. This achieves an optimal and situationally adapted heating of the wiper strip.

It is particularly advantageous if the heating element has a self-regulating semiconductor matrix, since the latter is simple, cost-efficient, and effective.

It is particularly advantageous in this respect if the semiconductor matrix is arranged between two conductors, and in particular copper conductors, since copper represents a very good electrical conductor and is, moreover, very corrosion-resistant.

Advantageously, at least one of the conductors, and preferably both conductors, are nickel-plated. This further increases the corrosion resistance.

It is, moreover, particularly advantageous if the heating element has a polyolefin and/or fluoropolymer sheath.

Furthermore, it is to be regarded as advantageous if the heating element is freely movable in the transverse direction. This further improves the self-regulating property.

Moreover, it is advantageous if the heating element is arranged in an insulated manner at one end in the longitudinal direction. This further improves the reliability of the heating.

It is particularly advantageous if an end cap is provided at both ends of the longitudinal extension of the wiper blade, and the heating element is insulated at the end-cap-side end in the longitudinal direction. The heating element can thus be contacted in a simple manner with a supply line on the wiper arm.

It is particularly advantageous in this respect if the insulated end of the heating element is arranged in the end cap. As a result, the wiper strip is heated optimally.

It is also advantageous if a fastening element for fastening to a wiper arm is provided between the end caps, and a contact end of the heating element is arranged in the region of the fastening element. This enables simple contacting of the heating element.

### DESCRIPTION OF THE DRAWINGS

An embodiment of the invention is shown in the drawings and explained in more detail in the following description.

In the drawings:

FIG. 1 shows a schematic, perspective view of a wiper blade according to the invention,

FIG. 2 shows a cross-section through a wind deflector strip of a wiper blade according to the invention,

FIG. 3 shows the cross-section of FIG. 2 with a heating element,

FIG. 4 shows a schematic, perspective, partial sectional view of a wind deflector strip,

FIG. 5 shows a heating element of a wiper blade according to the invention,

FIG. 6 shows a schematic, perspective, partial sectional view of a wiper lip, and

FIGS. 7a and 7b show cross-sections through a wiper lip of a wiper blade according to the invention in one variation.

### DETAILED DESCRIPTION

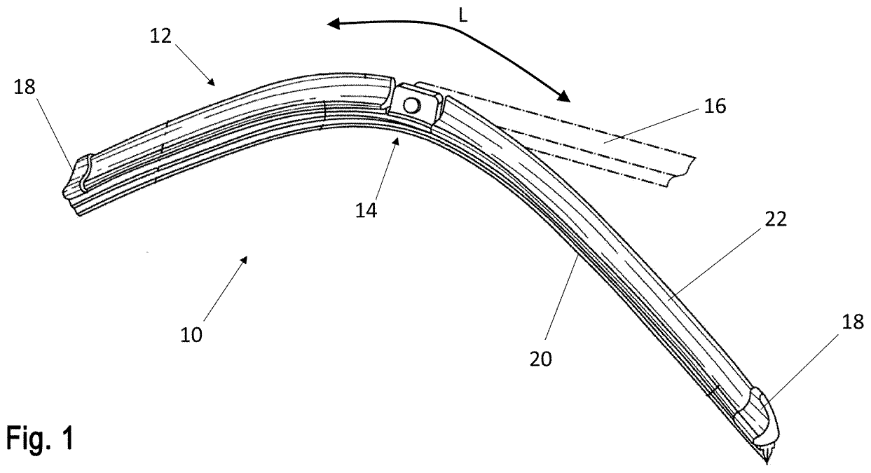

FIG. 1 shows a schematic, perspective view of a wiper blade 10 according to the invention. Said wiper blade comprises a wiper strip 12 and a fastening element 14 for fastening the wiper strip 12 to a wiper arm 16, which is not part of the invention. The wiper blade 10 has a longitudinal extension L. At each end with respect to the longitudinal extension L, the wiper strip 12 has an end cap 18, which terminates the wiper blade 10 with respect to its longitudinal extension L. On its underside lying on a pane to be wiped during operation, the wiper strip 12 has a wiper lip 20 which is capable of wiping moisture from the pane. On its upper side facing away from the pane, the wiper strip 12 has a wind deflector strip 22, toward which the airflow flows during operation, whereby the force with which the wiper strip 12 is pressed onto the pane is increased.

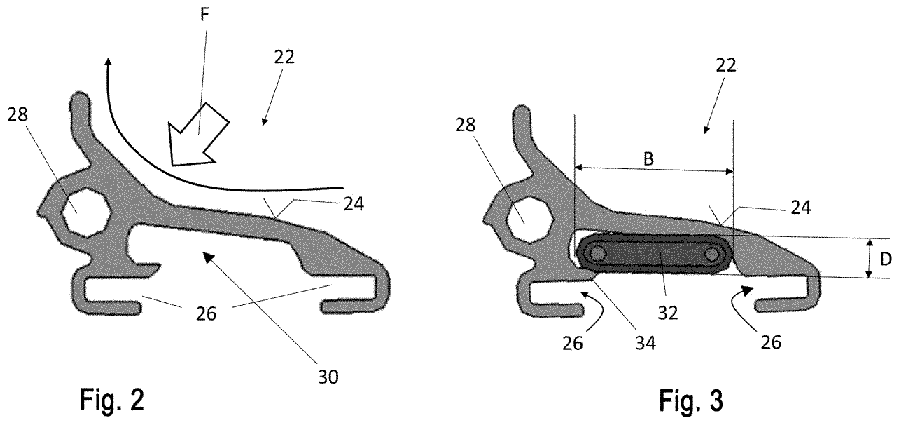

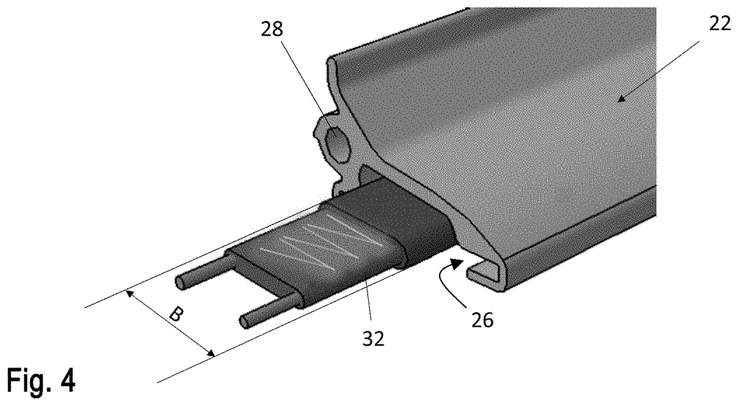

FIG. 2 shows a cross-section through the wind deflector strip 22 of the wiper blade 10 according to the invention.

The wind deflector strip 22 has a spoiler surface 24 and the incoming airflow is deflected in such a way that a force component F is produced downward, in the direction of the wiper lip 20 (FIG. 1). The wind deflector strip 22 is fastened by fastening rails 26 which encompass spring rails, which are not illustrated here for reasons of clarity. On the side facing away from the airflow, the wind deflector strip 22 moreover has a channel 28 which is intended for supplying cleaning fluid to cleaning nozzles. The channel 28 itself may also have openings for dispensing cleaning fluid.

Moreover, the wind deflector strip 22 has a receiving space 30 which serves to receive a self-regulating heating tape.

FIG. 3 shows the same cross-section through the wind deflector strip 22 of the wiper blade 10 according to the invention as shown in FIG. 2; but a heating element 32 designed as a self-regulating heating tape is inserted into the receiving space 30 here. Otherwise, FIG. 3 corresponds to FIG. 2, such that reference is made to the description of FIG. 2. The heating element 32 is thus arranged substantially in the interior of the wiper strip 12 and is thereby protected from environmental influences and airflow. The heating element 32 is elongate in cross-section and has a thickness D which is approximately a quarter of its width B. For mounting, a projection 34 on which the heating element 32 is supported is arranged on the receiving space 30 on the underside facing the fastening rails 26. As shown here, the projection 34 may be provided only on one side—here, the rear side facing away from the airflow. In a variation of the invention, however, a further projection may, alternatively or additionally, also be arranged on the front side facing the airflow. The width of the receiving space 30 is slightly larger than the width B of the heating element 32, such that the heating element 32 is freely movable in the transverse direction and can expand slightly in the transverse direction.

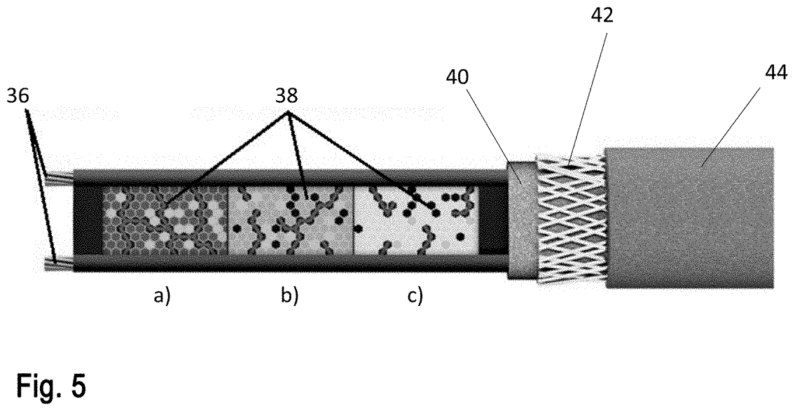

FIG. 5 shows a heating element 32 of a wiper blade 10 according to the invention in a schematic, partial, sectional view. A plastic, in which carbon particles are embedded, is arranged between two, nickel-plated, copper lines as conductors 36, such that a semiconductor matrix 38 is formed. If the temperature increases, the plastic expands, and the carbon particles separate more and more from one another, whereby the current paths are interrupted, and the heating power is reduced. In region a), the temperature is low, and the heating power is at a maximum. In region b), the temperature is slightly higher than in region a), as a result of which the heating power is reduced. In region c), the temperature is still higher than in region b) and, as a result, the heating power is reduced to a minimum, or equal to zero. As a result of this semiconductor matrix 38, the heating element 32 is self-regulating. The heating element 32 is surrounded by a fluoropolymer sheath 40, but a sheath made of a modified polyolefin is also possible here. Over it, a mesh 42 made of tin-plated copper strand is provided. The outer sheath 44, which extends over the mesh 42, is made of fluoropolymer or a modified polyolefin.

Two heating elements 32 designed as heating tapes are provided in the wiper blade 10 according to the invention. One heating tape extends from the fastening element 14 to an end cap 18. The other heating tape extends from the fastening element 14 to the other end cap 18. In the fastening element 14, the two heating tapes of the heating device 32 are contacted in that they are connected to an electrical supply line. This end of each heating tape constitutes the contact end. The electrical supply line runs through the wiper arm 16 to the fastening element 14. The other end of each heating tape is insulated. For this purpose, a stocking hose or a stocking cap can be used, for example, which is shrunk onto the cut-off end of the heating tape. This insulated end of the heating tape is arranged within the end cap 18. The insulation is therefore provided on the side of the end cap here. In a variation of the invention, the end cap 18 may also be designed to be sealing in such a way that a separate insulation of the end of the heating tape can be dispensed with. For this purpose, for example, additional sealing elements can be provided between the end cap 18 and the wind deflector strip 22.

In a further variation of the invention, the heating element 32, and thus the heating tape, may also be contacted on one of the end caps 18. The end cap 18 that is located close to the wiper arm 16 is suitable in this respect. The heating tape can thus run continuously from one end cap 18 to the other end cap 18.

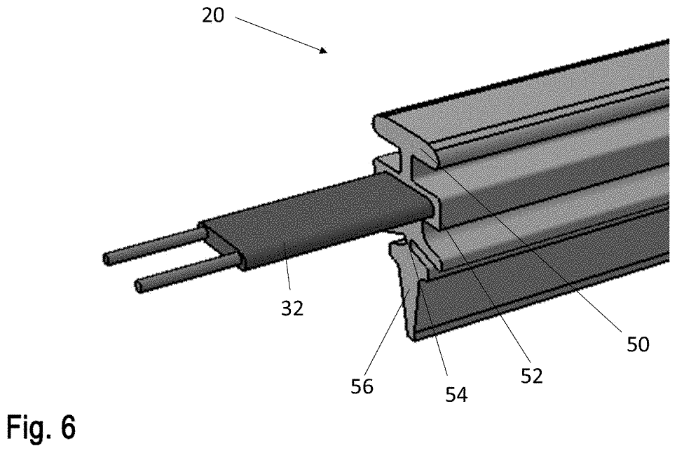

FIG. 6 shows the wiper lip 20 of a wiper blade 10 according to the invention in a variation. The heating element 32 designed as a self-regulating heating tape is arranged in the wiper lip 20 here. The wiper lip 20 itself comprises a fastening portion 50, which is approximately T-shaped in cross-section. The F-foot of the fastening portion 50 is adjoined by a damping portion 52 which is rectangular in cross-section and receives the heating element 32. This damping portion 52 is adjoined via a pendulum web 54 by a contact portion 56 which rests upon the pane to be wiped during operation and wipes moisture from it. The contact portion 56 is substantially triangular in cross-section, with one corner resting upon the pane to be wiped during operation. The wiper lip 20 is held by spring rails which engage between the damping portion 52 and the crossbar of the T-shaped fastening portion 50.

Contacting of the heating element 32 may in this case be provided in the region of the fastening element 14. For example, we can pass contact needles through the shell of the damping portion 52 and thus contact the conductors 36 of the heating element 32.

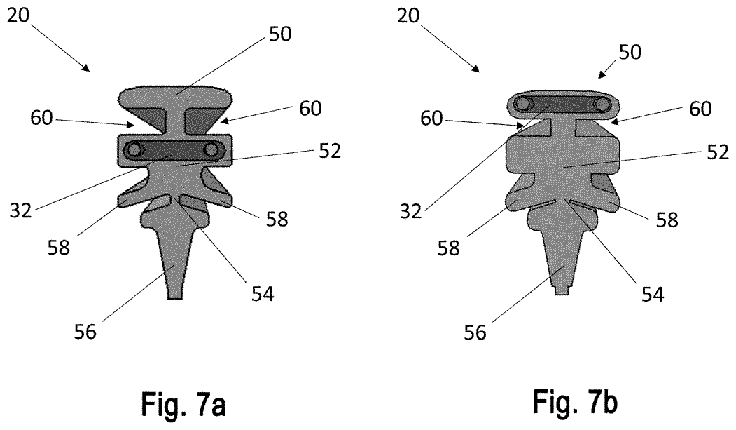

FIG. 7a shows the exemplary embodiment of FIG. 6 again in cross-section. The T-shaped fastening portion 50 arranged above is adjoined by the damping portion 52 which is substantially rectangular in cross-section. Damping wings 58, which dampen the noise arising at the damping portion 52 when the contact portion 56 connected via the pendulum web 54 stops, are provided on the damping portion 52. Due to the T-shaped design of the fastening portion 50, a retaining groove 60 is formed between the upper crossbar thereof and the damping portion 52 on each side, in each of which grooves a respective spring rail engages, which is not drawn here for reasons of clarity.

FIG. 7b shows the embodiment of FIGS. 6 and 7a in a variation. In this respect, only the differences are described. As in FIG. 7a, the wiper lip 20 is formed substantially in three parts. The fastening portion 50 which is approximately T-shaped in cross-section is adjoined by the damping portion 52, which is rectangular in cross-section and has damping wings 58 on its side facing away from the fastening portion 50. The contact portion 56 adjoins this damping portion 50 via the pendulum web 54.

The heating element 32 is arranged here in the fastening portion 50. The heating element 32 forms the upper crossbar of the T-shaped fastening portion 50. In a variation of the invention, the embodiments of FIG. 7a and FIG. 7b can also be combined.

The heating element 32 may also be contacted here via contacting needles which pierce into the fastening portion 50 and thus contact the conductors 36 of the heating element 32. In both exemplary embodiments, the contacting needles can be arranged in the region of the fastening element 14. Alternatively or additionally, however, an arrangement of the contacting needles in at least one of the end caps 18 is also possible.

If the heating element 32 is arranged in the wiper lip 20, the heating element 32 can be introduced together with the wiper lip 20 into the wiper lip 20 in an extrusion process. Here, the wiper lip 20 is extruded around the heating element 32 designed as a heating tape.

Contacting can also take place in that the fastening portion 50 or the damping portion 52 is opened, e.g., cut open, in the region of the fastening means 14 or of the end cap 18, and the conductors 36 of the heating element 32 are directly contacted or are bent upward against the direction of the of the contact portion 56.

EPDM is used here as the material for the wiper lip 20, wherein the wiper lip 20 is extruded from various EPDM compositions in a co-extrusion process.

1. A wiper blade (10) comprising a wiper strip (12) and a heating element (32), wherein the heating element (32) is a self-regulating heating element (32).

2. The wiper blade (10) according to claim 1, wherein the heating element (32) has a self-regulating semiconductor matrix (38).

3. The wiper blade (10) according to claim 2, wherein the semiconductor matrix (38) is arranged between two conductors (36).

4. The wiper blade (10) according to claim 3, wherein the two conductors (36) are copper conductors.

5. The wiper blade (10) according to claim 3, wherein at least one of the two conductors (36) is nickel-plated.

6. The wiper blade (10) according to claim 1, wherein the heating element (32) has a polyolefin and/or fluoropolymer sheath (40).

7. The wiper blade (10) according to claim 1, wherein the heating element (32) is freely movable in a transverse direction.

8. The wiper blade (10) according to claim 1, wherein the heating element (32) is arranged in an insulated manner at one end in a longitudinal direction (L).

9. The wiper blade (10) according to claim 1, wherein end caps (18) are provided at opposite ends of the wiper blade (10) along a longitudinal direction (L) of the wiper blade (10), and the heating element (32) is insulated at an end-cap-side end in the longitudinal direction (L).

10. The wiper blade (10) according to claim 9, wherein an insulated end of the heating element (32) is arranged in one of the end caps (18).

11. The wiper blade (10) according to claim 9, wherein a fastening element (14) for fastening to a wiper arm is provided between the end caps (18), and a contact end of the heating element (32) is arranged in a region of the fastening element (14).

12. The wiper blade (10) according to claim 1, wherein the wiper blade is a motor vehicle wiper blade.
